(19) United States
(12) Patent Application Publication
(10) Pub. No.: US 2025/0366591 A1
(43) Pub. Date: Dec. 4, 2025

(54) PREPARATION METHOD FOR INSTANTLY-PASTED PAINT NAILS

(71) Applicant: ChunMei WU, Guangzhou (CN)

(72) Inventor: ChunMei WU, Guangzhou (CN)

(21) Appl. No.: 18/752,641

(22) Filed: Jun. 24, 2024

Related U.S. Application Data
(63) Continuation-in-part of application No. 18/676,701, filed on May 29, 2024.

(51) Int. Cl. A45D 31/00; A45D 29/00

(52) U.S. Cl. CPC A45D 31/00; A45D 2029/005

(57) ABSTRACT

The invention belongs to the technical field of manicure, and discloses a preparation method for instantly-pasted paint nails. The method specifically includes applying a Acrylic Powder glue on a plastic fake nail piece and curing to form a Acrylic Powder layer, using an ink to print a preset pattern layer on the Acrylic Powder layer, and applying a brightening glue on the pattern layer and curing to form a brightening layer, so as to obtain the instantly-pasted paint nails. Through fine process steps and material selection, the invention can effectively improve the thickness and transparency of paint nails.

### TECHNICAL FIELD

The invention relates to the technical field of manicure, in particular, to a preparation method for instantly-pasted paint nails.

### BACKGROUND

In the prior art, the instantly-pasted paint nail is generally obtained by injection molding ABS/PMMA particles into plastic fake nail pieces using an injection molding machine at a high temperature of 250-300° C., and then printing on the formed plastic fake nail pieces. The instantly-pasted paint nail prepared by this method lacks thickness and transparency.

### SUMMARY

Based on the above problems, an embodiment of the invention provides a preparation method for instantly-pasted paint nails. The instantly-pasted paint nails prepared by the method of the present invention have a thick feeling and a transparent feeling. The invention has the following contents.

An objective of the invention is to provide a preparation method for instantly-pasted paint nails, which includes steps of:
step one, applying 1-3 layers of Acrylic Powder glue on a clean plastic fake nail piece and curing at 20-25° C. for 5-6 minutes to form a Acrylic Powder layer of 0.1-0.3 mm, wherein the Acrylic Powder glue includes a Acrylic Powder and a methyl methacrylate liquid with a mass volume ratio of 1 (g): 1 (mL), the plastic fake nail piece of the invention are square, square-round, pointed and oval plastic fake nail pieces obtained by dividing the plastic fake nail pieces into gradients according to a size of a human nail bed as Nos. 00, 0, 1, 2, 3, 4, 5, 6, 7, 8, 10, 11, 12, 13, 14 and 15 (each number is in millimeters) after molding through traditional injection molding technology, and the Acrylic Powder and the methyl methacrylate liquid of the invention are cured and adhered through polymerization reaction;
step two, using an ink to print a preset pattern layer on the Acrylic Powder layer of the step one, wherein the pattern layer on the surface has a decorative effect and adds beauty;
step three, applying a brightening glue on the pattern layer of the step two to achieve a bright and shiny surface and curing with a UV curing lamp for 120 seconds to form a brightening layer, so as to prepare the instantly-pasted paint nail, wherein a thickness for applying is 0.1-0.4 mm.

In order to better achieve the above technical solutions, a particle size of the Acrylic Powder in the step one of the preparation method for instantly-pasted paint nails according to the invention is 1-20 μm.

In order to better achieve the above technical solutions, a roughness of the Acrylic Powder in the step one of the preparation method for instantly-pasted paint nails according to the invention is 300-500 mesh.

In order to better achieve the above technical solutions, a method for applying in the step one of the preparation method for instantly-pasted paint nails according to the invention includes brushing or spraying.

In order to better achieve the above technical solutions, the Acrylic Powder in the step one of the preparation method for instantly-pasted paint nails according to the invention includes a mixture of a color powder, a shimmering powder and a transparent Acrylic resin powder.

In order to better achieve the above technical solutions, a mass ratio of the color powder, the simmering powder and the transparent acrylic resin powder of the preparation method for instantly-pasted paint nails according to the invention is 2:2:6.

In order to better achieve the above technical solutions, in the step three of the preparation method for instantly-pasted paint nails according to the invention, the brightening glue includes a resin and a photoinitiator.

Compared with the prior art, the preparation method for instantly-pasted paint nails according to the invention has the following beneficial effects:

The preparation method for instantly-pasted paint nails according to the invention includes applying 1-3 layers of Acrylic Powder glue on a clean plastic fake nail piece and curing at 20-25° C. for 5-6 minutes to form a Acrylic Powder layer, using an ink to print a preset pattern layer on the Acrylic Powder layer, and applying a brightening glue on the pattern layer and curing for 120 seconds to form a brightening layer, so as to prepare the instantly-pasted paint nails after the brightening layer is formed. Through fine process steps and material selection, the invention may effectively improve the thickness and transparency of paint nails.

### BRIEF DESCRIPTION OF DRAWINGS

The drawings described herein are intended to provide a further understanding of the invention, and are intended to be a part of this invention. The schematic embodiments of this invention and their descriptions are used to interpret this invention and do not constitute an undue limitation of this invention. In the drawings:

FIG. 1 is a plastic fake nail piece of the invention;

FIG. 2 shows the step one of forming a Acrylic Powder layer of the plastic fake nail piece according to the invention;

FIG. 3 shows instantly-pasted paint nails completed by the step three according to the invention.

### DETAILED DESCRIPTION OF THE EMBODIMENTS

In order to make the purpose, technical solutions and advantages of the invention clearer, the technical solutions of the invention will be clearly and completely described below with reference to specific embodiments of the invention and corresponding drawings. Obviously, the described embodiments are only a part of the embodiments of the present invention, but not the whole. Based on the embodiments of the invention, all other embodiments obtained by a person skilled in the art without involving any inventive effort are within the scope of the invention.

### Embodiment 1

A preparation method for instantly-pasted paint nails includes the following steps.

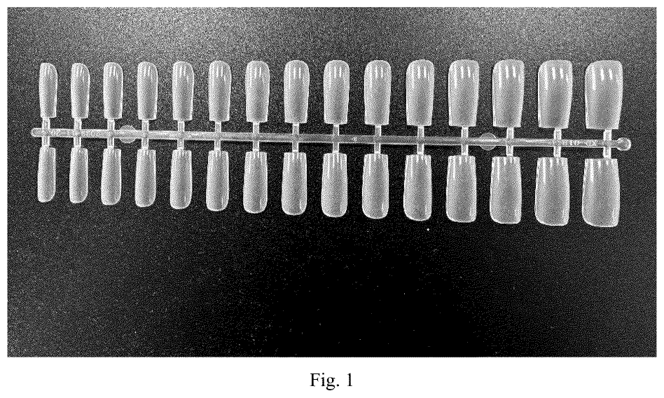

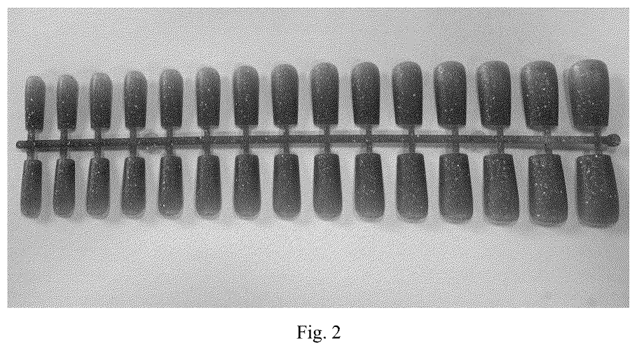

Step one, 2 layers of Acrylic Powder glue are applied on a clean plastic fake nail piece as shown in FIG. 1 and cured at 23° C. for 5 minutes to form a Acrylic Powder layer of 0.2 mm as shown in FIG. 2, wherein the Acrylic Powder glue includes a Acrylic Powder of 1000 g and a methyl methacrylate liquid of 1000 mL.

Step two, an ink is used to print a preset pattern layer on the Acrylic Powder layer of the step one.

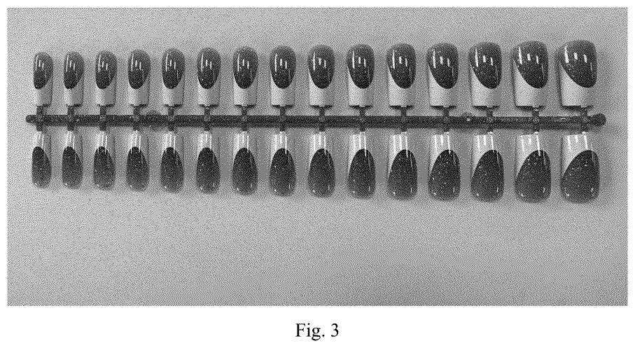

Step three, a brightening glue is applied on the pattern layer of the step two and cured with a UV curing lamp for 120 seconds to form a brightening layer, so as to prepare the instantly-pasted paint nail as shown in FIG. 3, wherein a thickness for applying is 0.3 mm.

Further, a particle size of the Acrylic Powder in the step one of the preparation method for instantly-pasted paint nails according to the embodiment is 10 μm.

Further, a roughness of the Acrylic Powder in the step one of the preparation method for instantly-pasted paint nails according to the embodiment is 400 mesh.

Further, a method for applying in the step one of the preparation method for instantly-pasted paint nails according to the embodiment includes brushing or spraying.

Further, the Acrylic Powder in the step one of the preparation method for instantly-pasted paint nails according to the invention includes a mixture of a color powder, a shimmering powder and a transparent Acrylic resin powder.

Preferably, a mass ratio of the color powder, the simmering powder and the transparent acrylic resin powder of the preparation method for instantly-pasted paint nails according to the embodiment is 2:2:6.

Further, in the step three of the preparation method for instantly-pasted paint nails according to the embodiment, the brightening glue includes a resin and a photoinitiator.

The instantly-pasted paint nails are tested for adhesion using a hundred-grid adhesive pull test. An adhesion level of the instantly-pasted paint nail according to the method of the embodiment is level 5.

### Embodiment 2

A preparation method for instantly-pasted paint nails includes the following steps.

Step one, 1 layer of Acrylic Powder glue are applied on a clean plastic fake nail piece as shown in FIG. 1 and cured at 20° C. for 6 minutes to form a Acrylic Powder layer of 0.3 mm as shown in FIG. 2, wherein the Acrylic Powder glue includes a Acrylic Powder of 1000 g and a methyl methacrylate liquid of 1000 mL.

Step two, an ink is used to print a preset pattern layer on the Acrylic Powder layer of the step one.

Step three, a brightening glue is applied on the pattern layer of the step two and cured with a UV curing lamp for 120 seconds to form a brightening layer, so as to prepare the instantly-pasted paint nail as shown in FIG. 3, wherein a thickness for applying is 0.2 mm.

Further, a particle size of the Acrylic Powder in the step one of the preparation method for instantly-pasted paint nails according to the embodiment is 1 μm.

Further, a roughness of the Acrylic Powder in the step one of the preparation method for instantly-pasted paint nails according to the embodiment is 300 mesh.

Further, a method for applying in the step one of the preparation method for instantly-pasted paint nails according to the embodiment includes brushing or spraying.

Further, the Acrylic Powder in the step one of the preparation method for instantly-pasted paint nails according to the invention includes a mixture of a color powder, a shimmering powder and a transparent Acrylic resin powder.

Preferably, a mass ratio of the color powder, the simmering powder and the transparent acrylic resin powder of the preparation method for instantly-pasted paint nails according to the embodiment is 2:2:6.

Further, in the step three of the preparation method for instantly-pasted paint nails according to the embodiment, the brightening glue includes a resin and a photoinitiator.

The instantly-pasted paint nails are tested for adhesion using a hundred-grid adhesive pull test. An adhesion level of the instantly-pasted paint nail according to the method of the embodiment is level 5.

### Embodiment 3

A preparation method for instantly-pasted paint nails includes the following steps.

Step one, 3 layers of Acrylic Powder glue are applied on a clean plastic fake nail piece as shown in FIG. 1 and cured at 20-25° C. for 6 minutes to form a Acrylic Powder layer of 0.1 mm as shown in FIG. 2, wherein the Acrylic Powder glue includes a Acrylic Powder of 1000 g and a methyl methacrylate liquid of 1000 mL.

Step two, an ink is used to print a preset pattern layer on the Acrylic Powder layer of the step one.

Step three, a brightening glue is applied on the pattern layer of the step two and cured with a UV curing lamp for 120 seconds to form a brightening layer, so as to prepare the instantly-pasted paint nail as shown in FIG. 3, wherein a thickness for applying is 0.4 mm.

Further, a particle size of the Acrylic Powder in the step one of the preparation method for instantly-pasted paint nails according to the embodiment is 20 μm.

Further, a roughness of the Acrylic Powder in the step one of the preparation method for instantly-pasted paint nails according to the embodiment is 500 mesh.

Further, a method for applying in the step one of the preparation method for instantly-pasted paint nails according to the embodiment includes brushing or spraying.

Further, the Acrylic Powder in the step one of the preparation method for instantly-pasted paint nails according to the invention includes a mixture of a color powder, a shimmering powder and a transparent Acrylic resin powder.

Preferably, a mass ratio of the color powder, the simmering powder and the transparent acrylic resin powder of the preparation method for instantly-pasted paint nails according to the embodiment is 2:2:6.

Further, in the step three of the preparation method for instantly-pasted paint nails according to the embodiment, the brightening glue includes a resin and a photoinitiator.

The instantly-pasted paint nails are tested for adhesion using a hundred-grid adhesive pull test. An adhesion level of the instantly-pasted paint nail according to the method of the embodiment is level 5.

The above is embodiments of the invention and is not intended to limit the invention. Various changes and modifications may be made to the present invention by those skilled in the art. Any modifications, equivalent substitutions, improvements and the like within the spirit and principles of the present invention are all intended to be included within the scope of the claims of the present invention.

What is claimed is:

1. A preparation method for instantly-pasted paint nails, comprising steps of:
step one, applying 1-3 layers of Acrylic Powder glue on a clean plastic fake nail piece and curing at 20-25° C. for 5-6 minutes to form a Acrylic Powder layer of 0.1-0.3 mm, wherein the Acrylic Powder glue comprises a Acrylic Powder and a methyl methacrylate liquid with a mass volume ratio of 1 (g): 1 (mL);
step two, using an ink to print a preset pattern layer on the Acrylic Powder layer of the step one;
step three, applying a brightening glue on the pattern layer of the step two and curing with a UV curing lamp for 120 seconds to form a brightening layer, so as to prepare the instantly-pasted paint nail, wherein a thickness for applying is 0.1-0.4 mm.

2. The preparation method for instantly-pasted paint nails according to claim 1, wherein a particle size of the Acrylic Powder in the step one is 1-20 μm.

3. The preparation method for instantly-pasted paint nails according to claim 1, wherein a roughness of the Acrylic Powder in the step one is 300-500 mesh.

4. The preparation method for instantly-pasted paint nails according to claim 1, wherein a method for applying in the step one comprises brushing or spraying.

5. The preparation method for instantly-pasted paint nails according to claim 1, wherein the Acrylic Powder in the step one comprises a mixture of a color powder, a shimmering powder and a transparent Acrylic resin powder.

6. The preparation method for instantly-pasted paint nails according to claim 5, wherein a mass ratio of the color powder, the simmering powder and the transparent acrylic resin powder is 2:2:6.

7. The preparation method for instantly-pasted paint nails according to claim 1, wherein in the step three, the brightening glue comprises a resin and a photoinitiator.
